(19) United States
(12) Patent Application Publication
(10) Pub. No.: US 2007/0248447 A1
(43) Pub. Date: Oct. 25, 2007

(54) Component transport method and combination structure of component transport container and transferring jig and component transport container and supporting jig

(75) Inventor: Kinji Mikami, Takasaki-shi (JP)

Correspondence Address: SUGHRUE-265550, 2100 PENNSYLVANIA AVE. NW, WASHINGTON, DC, 20037-3213, US

(73) Assignee: NSK Ltd., Tokyo (JP)

(21) Appl. No.: 11/785,664

(22) Filed: Apr. 19, 2007

(30) Foreign Application Priority Data
Apr. 19, 2006 (JP) 2006-115747

(51) Int. Cl. B65G 57/00

(52) U.S. Cl. 414/788

(57) ABSTRACT

Components are transported from a manufacturing factory to an assembly factory after accommodated in accommodating spaces 20 of a hollow transport container 14 made of high polymer material at the manufacturing factory. At the assembly factory, the transport container 14 is placed on a supporting jig 15. At that time, supporting walls provided on a top surface of the supporting jig 15 are inserted into hollow structure of the container 14. Then, in a state in which the transport container 14 is thus supported, the components accommodated in the accommodating spaces 20, 20 are taken out through opening in the longitudinal direction of pair of end walls 17, 17 and intermediate walls 18, 18. The above problem is solved by reducing weight of the transport container 14 and also eliminating the need of sending back the transport container 14 to the manufacturing factory.

### BACKGROUND OF THE INVENTION

1. Field of the Invention

The present invention relates to a transport method of transporting, for example, a cam follower with a plurality of needle rollers, which constitutes a valve operating mechanism of an engine, from a factory manufacturing the cam follower with the needle rollers to a plant assembling the engine. The invention also relates to an improvement of a transport container for use in the transport. Additionally, the invention intends to realize the transport container with a supporting jig which ensures the usability of the transport container and with a transferring jig which improve efficiency at the time of transferring the transport container.

2. Description of Related Art

Reciprocating engines, except for some 2-cycle engines, are provided with intake valves and exhaust valves, which open and close in synchronization with the rotation of a crankshaft. In such a reciprocating engine, the motion of a camshaft that rotates in synchronization with the rotation of the crankshaft (in the case of a 4-cycle engine, the rotating speed of the camshaft is ½ that of the crankshaft) is transmitted to valve elements, which are the intake valves or the exhaust valves, by a rocker arm to reciprocate the intake valves and the exhaust valves in an axial direction. For example, Japanese Patent Unexamined Publications JP-A-2003-112225 and JP-A-2004-100499 have described a structure in which a cylindrical cam follower is rotatably supported by a radial needle bearing on a component of a rocker arm engaging with the outer circumferential surface of a cam fixed to the camshaft so as to reduce friction resistance to a low value and as to enhance the performance (for example, the maximum output power or the mileage) of the engine. Thus, this structure has become widely known and implemented.

FIG. 16 illustrates an example of the structure of a rocker arm device described in the JP-A-2003-112225. This rocker arm device has a rocker arm 1, a pivot shaft 2, a roller 3, a plurality of needle rollers 4, 4, and a spacer 5. The rocker arm 1 is manufactured by performing press working on a metal plate such as a steel plate, or performing die-casting on light alloy metal. Also, the pivot shaft 2 is made of hard metal such as bearing steel and is supported and fixed to paired support wall portions 6, 6 of the rocker arm 1 at both end portions in a state in which the rocker arm device is fabricated. Also, the entire roller 3 is cylindrically formed of hard metal, such as bearing steel, and is supported rotatably around the pivot shaft 2 through the each of the needle rollers 4, 4. Additionally, the spacer 5 is provided between both axial end surfaces of each of the needle rollers 1 and both the support wall portions 6, 6. Incidentally, the spacer 5 is frequently omitted.

An operation of assembling the aforementioned rocker arm device is performed in, for example, an engine assembly factory. Each of the above components 1 to 5, which is manufactured in a manufacturing factory, is transported to this assembly factory. Because all the above components 1 to 5 are small, many components of the same kind are transported to the manufacturing factory to the assembly factory by being accommodated in a single container. In this case, it is necessary from the viewpoint of streamlining the assembly operation in the assembly factory (that is, facilitating an assembly robot's handling of components) to maintain a constant posture of the individual components. For example, the roller 3 and the needle rollers 4, 4 are formed into a unit 7 in a condition in which a predetermined number of the needle rollers 4, 4 are stuck onto the inner circumferential surface of the roller 3 with grease, as shown in FIG. 16, at the manufacturing factory. Additionally, a plurality of such units 7 are accommodated in a transport container 8 schematically illustrated in FIGS. 17 to 19 to be in a state in which the central axes of the units 7 are parallelized to one another. Then, such units 7 are transported to the assembly factory from the manufacturing factory. Incidentally, a cylindrical spacer made of an elastic material, such as rubber, into the central portion of each of the units 7 by a light interference fit, as needs arise. This more surely prevents each of the needle rollers 4, 4 from improvidently dropping off the inner circumferential surface of the roller 3. The spacers are removed therefrom and are collected at the assembly factory.

The transport container 8 is manufactured by cutting a material, which is produced by performing extrusion molding on an aluminum alloy, to a predetermined length, and by also performing cutting work on this material. The transport container 8 has a flat-plate-like bottom plate portion 9 and a plurality of walls 10a and 10b upwardly erected from the bottom plate portion 9. Then, a space provided between each of pairs of the walls 10a and 10b adjoining in a width direction (the direction of an arrow a shown in FIG. 17) is used as an accommodating space 11 that accommodates each of the units 7. The units 7 are respectively accommodated in the accommodating spaces 11, 11 so that the direction of the central axis of each of the units 7 is aligned with the width direction of the transport container 8, and that the units 7 are disposed in series in the longitudinal direction (the direction of an arrow b shown in FIG. 17) of the transport container 8. Both end portions of a pair of shutter members 13 (only one of the shutter members 13 is shown in FIG. 17) are respectively caught in catching cutouts 12, 12 formed in tops of both end portions in the longitudinal direction of the walls 10a, 10a in the width direction of the transport container 8, as illustrated in FIGS. 17 to 19. Thus, both end portions of each of the accommodating spaces 11, 11 are blocked up. Consequently, the units 7 are prevented from being improvidently dropped off from openings in both end portions of the accommodating spaces 11, 11. The openings formed in both end portions of each of the accommodating spaces 11, 11 are closed by both the shutter members 13 while the container 8 is transported from the manufacturing factory to the assembly factory. In contrast, in a state in which the container 8 is set in the assembly robot in the assembly factory, one of the shutter members 13 is detached therefrom. Then, the units 7 accommodated in the accommodating spaces 11, 11 are taken out therefrom one by one and are assembled to other articles, such as the rocker arm 1 and the pivot shaft 2. The transport container 8 is reused by being sent back from the assembly factory to the manufacturing factory after all the units 7 are taken out therefrom.

Thus, in a case where the units 7 are transported from the manufacturing factory to the assembly factory by using the container 8, accommodation efficiency is degraded and transportation cost mounts up due to the bulky weight and capacity of the container 8. Also, many containers 8 are needed so as to be ceaselessly circulated between the manufacturing factory and the assembly factory. That is, in addition to the containers 8 accommodating units 7 which are being transported from the manufacturing factory to the assembly fact and are called “distribution stock”, transport containers 8 to be used to send back the units 7 from the assembly factory to the manufacturing factory are also needed. Accordingly, to ceaselessly supply the units 7 from the manufacturing factory to the assembly factory, it is necessary to increase the number of the transport containers 8 to a substantial value. Especially, in a case where components are supplied by ship from a domestic manufacturing factory to a foreign assembly factory, what is called “floating stock” is bulky. Consequently, a vast number of the transport containers are needed. Because the transport container 8 is made of an aluminum alloy, the manufacturing cost of the transport container 8 is high. Therefore, the supplying of the units 7 using a vast number of such transport containers 8 has a considerable negative effect on the price-reduction of the units 7.

### SUMMARY OF THE INVENTION

The invention is accomplished in view of the aforementioned circumstances to realize a component transport method, a component transport container, and the combination of a component transport container and a supporting jig, which are enabled to reduce the distribution cost of components and to achieve the reduction of the cost thereof.

According to a first aspect of the present invention, there is provided a component transport method using a component transport container and a transferring jig,

the component transport container that accommodates plural components along with a longitudinal direction and is made of high polymer material, the component transport container comprising:
a bottom plate;
a pair of end walls provided on width direction both ends thereof;
plurality of intermediate walls provided between the end walls;
a connecting wall that is provided on one end and connects one end of the end wall to one end of the intermediate wall;
a component accommodating space surrounded by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side,

the transport method comprising:

accommodating the plurality of components into the component accommodating space along with the longitudinal direction;

inserting a support plate of the transferring jig under a lower surface of the component transport container and stacking the component transport containers; and

transporting the component transport containers while the component transport containers are stacked state.

According to a second aspect of the invention, there is provided a component transport method using a component transport container and a supporting jig,

the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounded by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side,

the supporting jig supporting the component transport container from lower side and comprising:
a base plate supporting the bottom plate of the component transport container; and
a supporting wall inserted into the hollow structure,
wherein the supporting jig has rigidity higher than that of the component transport container,

the transport method comprising:

inserting the supporting wall of the supporting jig into the hollow structure of the component transport container; and

taking out the component from the taking out opening.

According to a third aspect of the invention, according to the second aspect of the invention, it is preferable that

from a state of closing the taking out opening which is closed by engaging respective cutout portions provided on the other end of the respective intermediate walls of the component transport container with a shutter member extending in the width direction, the shutter member is removed from the taking out opening, and

the component is taken out from the taking out opening.

According to fourth and fifth aspects of the invention, as set forth in the second and third aspects of the invention, it is preferable that from a state of stacking the plural component transport container, a transferring jig provided with a support plate is inserted under a lower surface of an upper most component transport container and the upper most component transport container is removed, and

the removed upper most component transport container is transferred to an upper surface of the supporting jig from the support plate of the transferring jig and the supporting wall of the supporting jig is inserted into the hollow structure of the component transport container.

According to a sixth aspect of the invention, there is provided a combination structure of a component transport container and a supporting jig, the combination structure comprising:

the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounding by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side; and

the supporting jig supporting the component transport container from lower side and comprising:
a base plate supporting the bottom plate of the component transport container; and
a supporting wall inserted into the hollow structure,
wherein the supporting jig has rigidity higher than that of the component transport container,

wherein supporting wall of the supporting jig is inserted into the hollow structure of the component transport container.

In the sixth aspect of the invention, the supporting jig may have rigidity higher than that of the component transport container so as to improve rigidity of the combination structure.

According to a seventh aspect of the invention, there is provided a combination structure of a component transport container and a transferring jig, the structure comprising:

the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounding by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side; and

the transferring jig comprising a support plate,

wherein the support plate of the transferring jig supports the component transport container from lower side.

In accordance with the component transport method, the component transport container, and the combination of the component transport container and the supporting jig, which are adapted according to the invention, the distribution cost of components is reduced. Thus, the cost of the components can be reduced. Reasons therefor are described below.

First, the material cost and the manufacturing cost of the component transport container are suppressed to low values, because the component transport container is made of the high polymer material. Thus, the cost of the component transport container itself can be suppressed to a low value. This fact results in elimination of the necessity for sending back the component transport container after the components are taken out of the accommodating portions of the component transport container at the assembly factory. Consequently, the cost of the components can be reduced by eliminating the transportation cost of sending back the empty component transport container to the manufacturing factory.

At the time of transporting the component transport containers, it is efficient to transport the plural component transport containers at the same time in a state of stacking the component transport containers. However, because the component transport container according to the present invention is made of resin, rigidity of the component transport container of the present is smaller than the conventional metallic component transport container. Therefore, when stacking the component transport containers without any counter measures, there is a fear that the component transport container may be broken or deformed so that the component contained in the component transport container fail off therefrom.

Therefore, at the time of stacking the component transport container, by inserting a support plate of the transferring jig under a lower surface of the component transport container, the breakage or deformation of the container can be prevented. In addition to the support plate, because the end wall portion is especially easy to be broken or deformed, the transferring jig may be provided with an edge portion support plate which supports the end wall portion of the component transport container.

Note that when transporting the component transport container in the stacking state, the rigidity of whole of the stacked component transport container is improved, the breakage or deformation of the component transport container at the time of transporting can be reduced. Further, it is preferable to transport the component transport container by wrapping the stacked component transport containers by packing material such as card boards. In that case, the breakage or deformation of the component transport container can be surely prevented.

At the time of taking out the component in the component transport container, by using the transferring jig, the component transport container is removed one by one. As described above, since there is a fear of breakage or deformation at the time of taking out the component transport container, the transferring jig is used to prevent the breakage or the deformation.

When using the packing material, it is preferable to use the packing material which opens to side direction. In that case, at the time of taking out the component from the container, the transferring jig can be easily inserted under a lower surface of the stacked containers so as to abut the lower surface of the container.

Also, because the component transport container is made of resin, the weight of the component transport container can be suppressed to small values. Thus, the transportation cost per unit can be suppressed to a low value by reducing the weight of portions (needed for packing) other than the components.

Incidentally, the component transport container is made of a high polymer material, so that the rigidity of the component transport container is reduced. This may result in that the positioning of each of the components accommodated in the component transport container is unstable, and that the component transport container cannot be set in the assembly robot in predetermined positional relationship at the assembly factory. However, according to the present embodiment of the invention, before the units are taken out of the component transport container at the assembly factory, the component transport container is placed on the supporting jig. Then, the supporting walls are inserted into both the end walls and the intermediate walls. In this state, both the end walls and the intermediate walls, which are made of a synthetic resin material and are hollow, are supported by the supporting walls. Thus, the shapes of both the end walls and the intermediate walls are stabilized. Therefore, the units can stably be taken out in the same posture by taking out the units through the opening portion formed between the same side end portions in the longitudinal direction of the adjacent two of both the end walls and the intermediate walls.

### BRIEF DESCRIPTION OF THE DRAWINGS

FIG. 1 is a schematic exploded perspective view illustrating an embodiment of the invention, which includes a transport container, a shutter member, and a supporting jig;

FIG. 2 is a plan view also illustrating the concrete shape of the transport container;

FIG. 3 is a cross-sectional view taken on line III-III shown in FIG. 2;

FIG. 4 is a cross-sectional view taken on line IV-IV shown in FIG. 2;

FIG. 5 is an enlarged cross-sectional view taken on line V-V shown in FIG. 2;

FIG. 6 is an enlarged cross-sectional view taken on line VI-VI shown in FIG. 2;

FIG. 7 is a plan view illustrating the shutter member;

FIG. 8 is a cross-sectional view taken on line VIII-VIII shown in FIG. 7;

FIG. 9 is an enlarged cross-sectional view taken on line IX-IX shown in FIG. 7;

FIG. 10 is an enlarged cross-sectional view taken on line X-X shown in FIG. 7;

FIG. 11 is a perspective view illustrating a state in which a packaging is unpacked at an assembly factory;

FIG. 12 is a perspective view illustrating a transferring jig;

FIG. 13 is a partially perspective view illustrating a sate in which the transport container is placed on the transferring jig;

FIG. 14 is a componential perspective view which illustrates a state of the transport container that accommodates units and that is placed on the supporting jig, and which is taken from the side of an opening of an accommodating space;

FIG. 15 is a componential perspective view which also illustrates the state of the transport container that accommodates units and that is placed on the supporting jig, and which is taken from the side opposite to the opening of an accommodating space;

FIG. 16 is an exploded perspective view illustrating an example of a rocker arm device;

FIG. 17 is a schematic perspective view illustrating a conventional transport container;

FIG. 18 is a partially perspective view that illustrates a state in which units are accommodated in the conventional transport container, and that is taken from one end of the container; and

FIG. 19 is a componential perspective view that illustrates the state in which units are accommodated in the conventional transport container, and that is taken from the other end of the container.

### DETAILED DESCRIPTION OF EXEMPLARY EMBODIMENTS OF THE INVENTION EMBODIMENTS

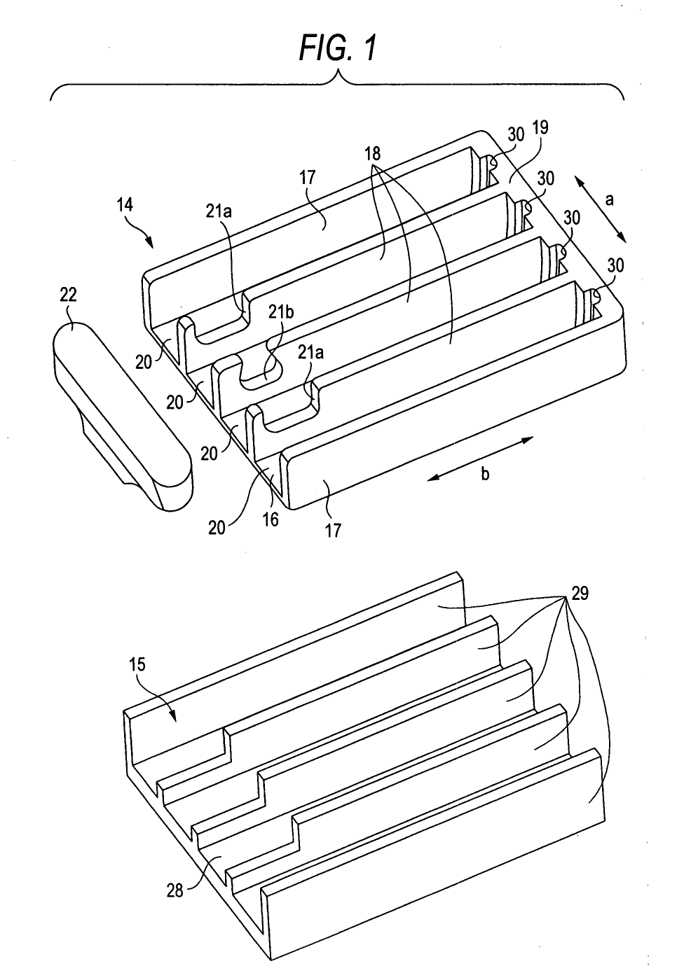

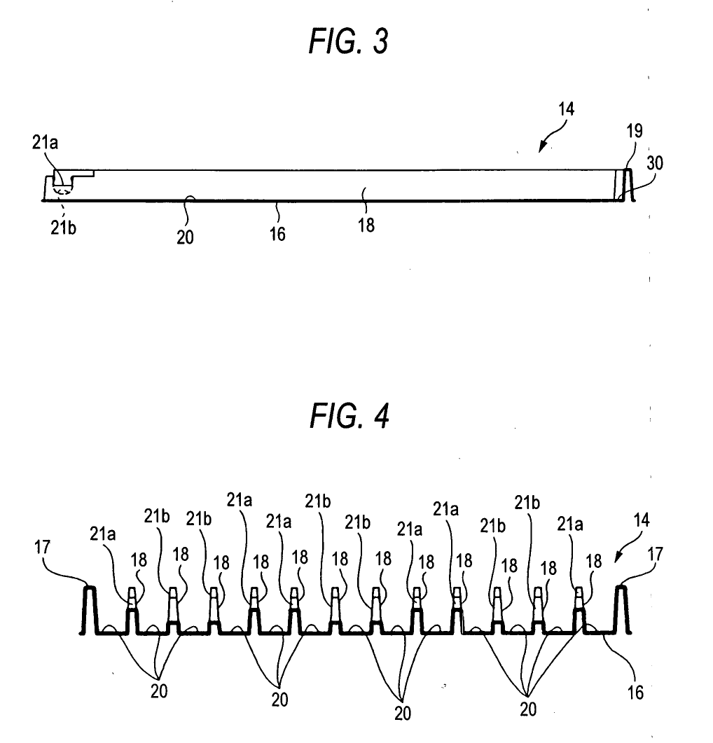

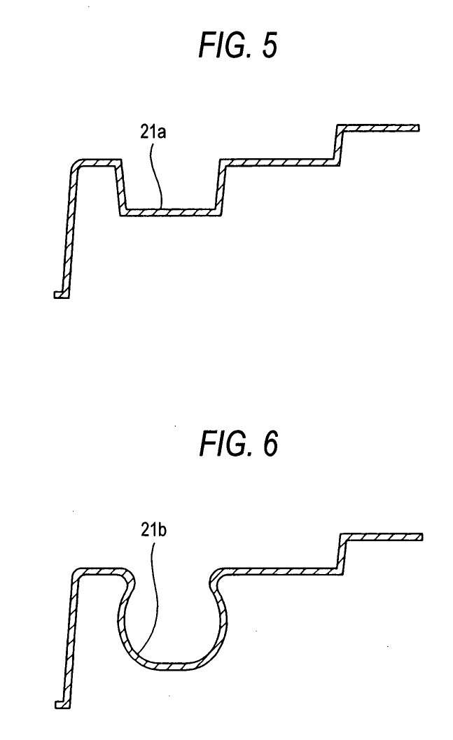

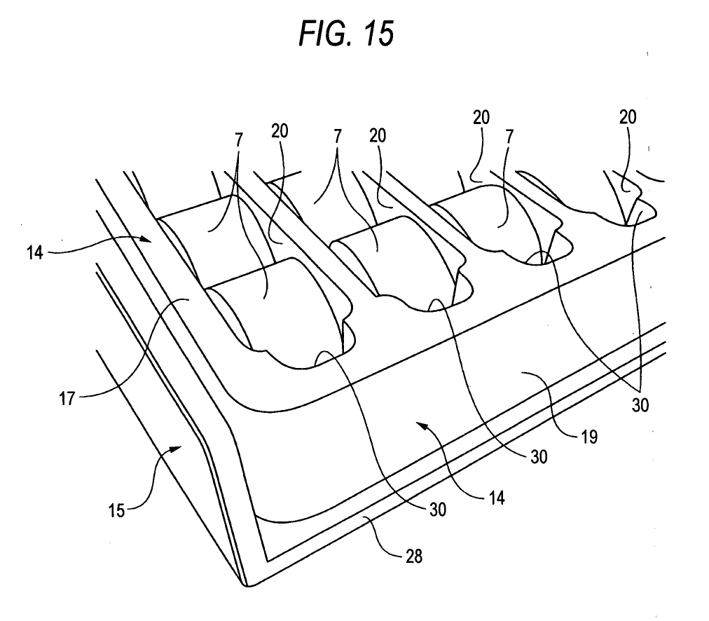

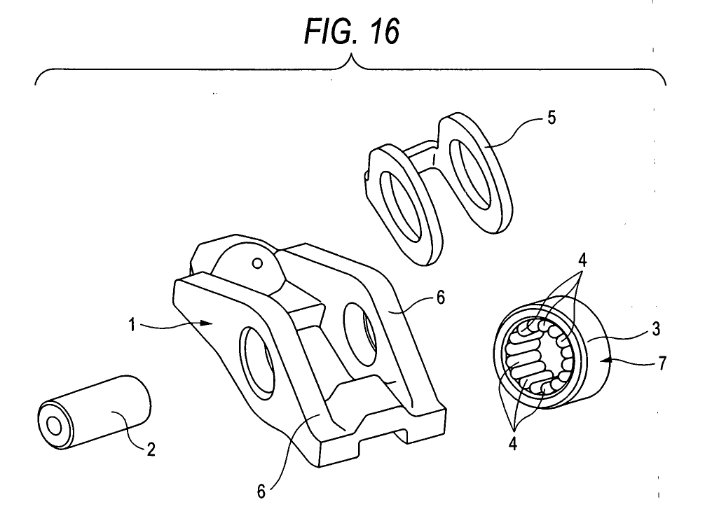

FIGS. 1 to 15 illustrate an embodiment of the invention. First, the structure of a transport container 14 is described with reference to FIGS. 1 to 10. The transport container 14 is assumed to be made of a high polymer material. For example, polypropylene (PP) is appropriate as the high polymer material. However, another high polymer material may be used, as long as this material can be formed into a thin-walled stable shape. Preferably, the wall thickness of the transport container 14 (that is, the degree of thinness of the transport container 14) is reduced as much as possible within a range in which the material can be stably processed and in which the necessary minimum strength of the transport container 14 can be assured. For example, in a case where the transport container 14 is made of PP, preferably, the wall thickness of the transport container 14 is set to be equal to or less than 0.5 mm (more preferably, 0.3 mm). Incidentally, in a case where the wall thickness of the transport container 14 is set to be less than 0.1 mm, even in consideration of the use of a supporting jig 15 which will be described later, it is difficult to assure the necessary minimum strength of the transport container 14. Incidentally, cross-sectional portions of the transport container 14, which are illustrated in FIGS. 3 and 4, (and a cross-sectional portion of a shutter member 22 (to be described later), which is shown in FIG. 8) are represented by solid lines, as compared with contour lines. A method of manufacturing the transport container 14 using the synthetic resin material is not limited to a specific method. The accuracy of a manufacturing mold can be assured. Also, in a case where the transport container 14 can be taken out of the mold after taken out of the transport container 14, the container 14 can be formed by injection-molding. Incidentally, in a case where, it is difficult to assure the accuracy due to the cost problem or where the transport container 14 has a problem in taking the molded container out of the mold, the container can be formed by blow-molding.

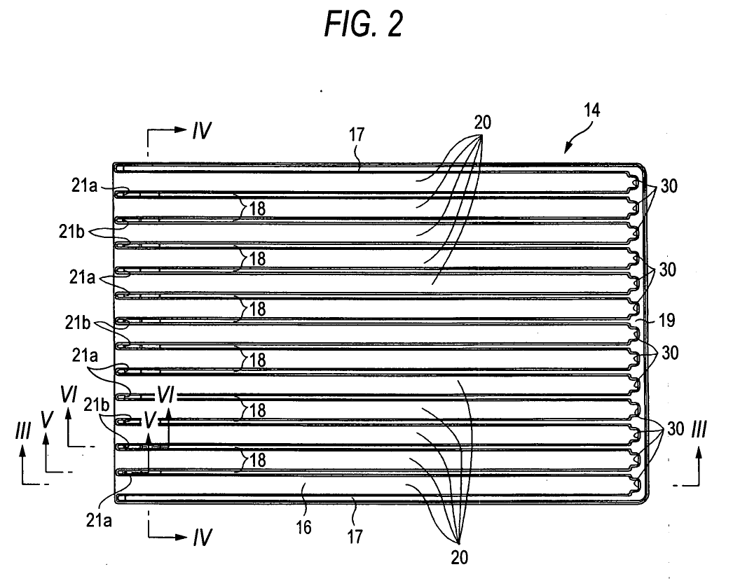

Whichever method is used to manufacture the transport container 14, the manufactured container 14 includes a bottom plate portion 16, a pair of end walls 17, 17, a plurality of intermediate walls 18, 18, and a connecting wall 19. Both the end walls 17, 17 are respectively formed on the top surfaces of both the end portions in the width direction (the direction indicated by an arrow a shown in FIG. 1, the up-down direction as viewed in FIG. 2, or the front-rear direction as viewed in FIG. 3) of the bottom plate 16 to be upwardly protruded from the top surfaces in parallel to each other. Also, each of the intermediate walls 18, 18 is formed on a componential top surface of the bottom plate portion 16, which lies between both the end walls 17, 17 to upwardly protrude from the top surface of the bottom plate portion 16. Additionally, the intermediate walls 18, 18 are arranged at intervals on the componential top surface in the width direction of the container 14 between both the walls 17, 17 in parallel to one another. Also, the connecting walls 19 are formed on the top surface of one end portion in the longitudinal direction of the bottom plate portion 16 to be connected to one end portion of each of both the end walls 17, 17 and the intermediate walls 18, 18.

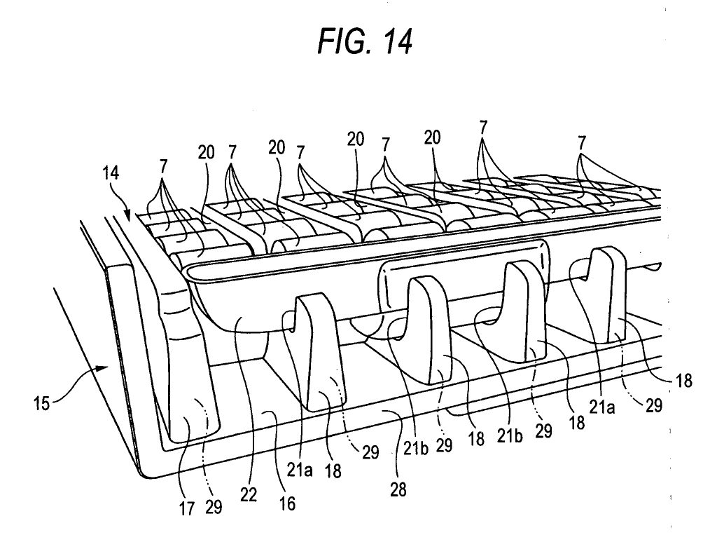

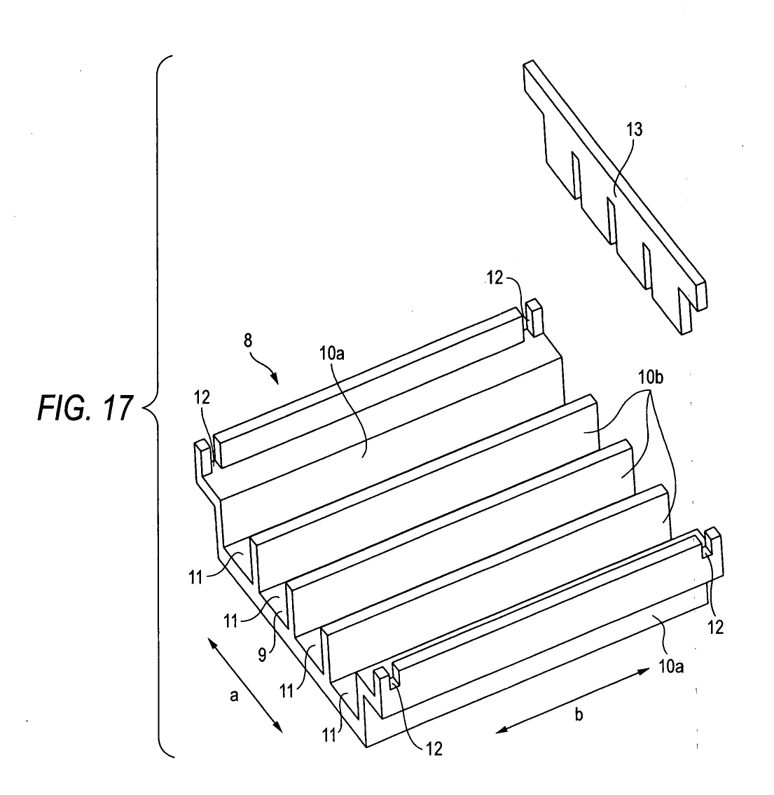

Each of the walls 17 to 19 has a hollow structure in which the bottom surface side of each of the walls 17 to 19 is opened. The inner surfaces of each of the walls 17 to 19 are inclined so that the distance between the opposed inner surfaces thereof decreases with distance from the bottom plate portion 16 (or towards the top end thereof). Therefore, the outer surfaces of each of both the walls 17, 17 and the intermediate walls 18, 18 are inclined so that the distance between the opposed outer surfaces thereof increases with distance from the bottom plate portion 16 (or towards the top end thereof). Portions of the top surface of the transport container 14, each of which is enclosed by the walls 17 to 19 on three sides thereof, constitute the accommodating spaces 20, 20 to be used to accommodate the units 7, 7 (see FIGS. 14 to 16) each of which is constituted by combining the roller 3 with the needle rollers 4. The width (the inside dimension) of the top portion of each of the accommodating spaces 20, 20 is larger than the axial width of each of the units 7, 7. The width (the inside dimension) of the bottom portion of each of the accommodating spaces 20, 20 is smaller than the axial width of each of the units 7, 7. Therefore, each of the units 7, 7 can freely be pushed into a corresponding one of the accommodating spaces 20, 20 by elastically deforming side wall portions of both the end walls 17, 17 and the intermediate walls 18, 18. The units 7, 7 are accommodated in the accommodating spaces 20, 20 without play in a state in which the units 7, 7 are pushed into the accommodating spaces 20, 20 a component of the outer circumferential surface of the roller 3 abuts against the bottom plate portion 16. Conversely to the foregoing description, the width of each of the accommodating spaces 20, 20 can be set to be slightly larger than that of each of the units 7, 7. In this case, the adhesion of rust preventive oil, which has adhered to each of the units 7, 7, to the inner surface of the accommodating spaces 20, 20 is minimized. Frictional resistance caused by moving the units 7, 7 toward the opening portion of each of the accommodating spaces. 20, 20 can be suppressed to a low level. While the looseness of each of the units 7, 7 in the accommodating spaces 20, 20 is minimized, an operation of taking out the units 7, 7 from the accommodating spaces 20, 20 can be facilitated.

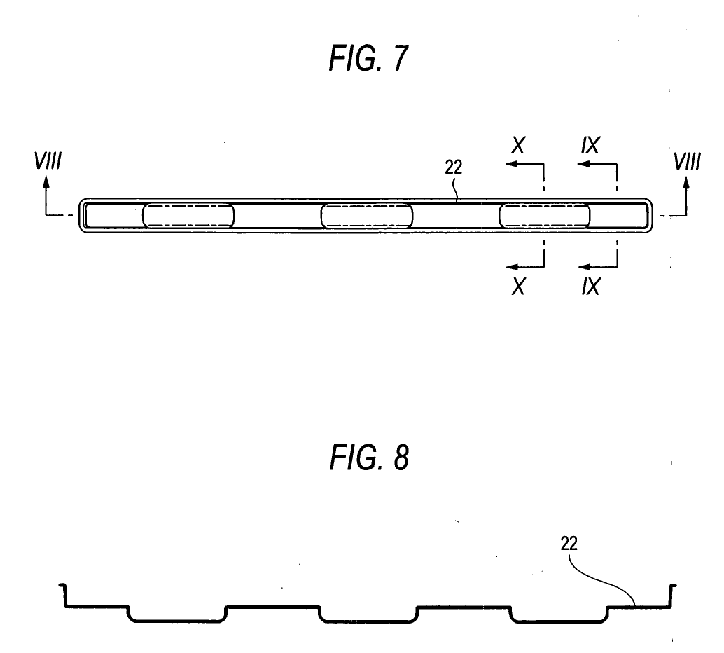

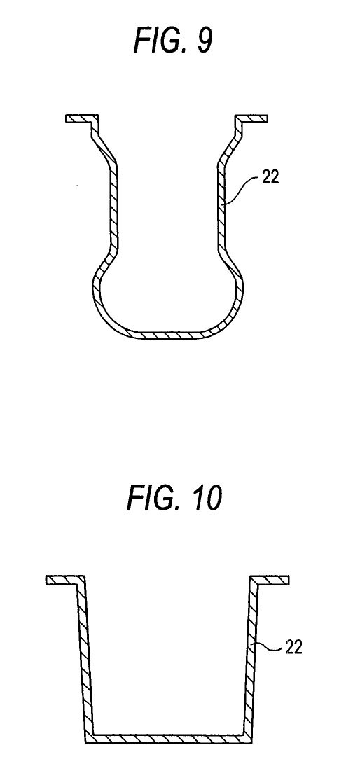

Also, rectangular or drawstring-bag-like cutout portions 21a, 21b are formed in the other end portions in the longitudinal direction of the intermediate walls 18, 18, respectively. The shutter member 22 shown in FIG. 1 (regarding the concrete shape of the shutter member 22, see FIGS. 7 to 10) is detachably attached in each of the cutout portions 21a and 21b. The shutter member 22 is made of a high polymer material, which is similar to that of the transport container 14, by performing a manufacturing method similar to that for the transport container 14. The shutter member 22 is boat-shaped as a whole, and is opened in the top portion thereof. As shown in FIGS. 9 and 10, a component of a cross-section of the shutter member 22 is shaped like a rectangle or a money-pouch in conformity to the shape of each of the cutout portions 21a and 21b so that the shutter member 22 is elastically disengageably engaged with the cutout portions 21a and 21b in a state in which the shutter member 22 is disposed to extend in the width direction of the transport container 14. Also, as shown in FIG. 14, the opening portion of each of the accommodating space 20, 20 is closed in a state in which a component of the shutter member 22 is engaged with each of the cutout portions 21a, 21b. Consequently, the units 77 accommodated in the accommodating spaces 20, 20 are prevented from being slipped off the accommodating spaces 20, 20.

Incidentally, the transport container 14 does not especially large strength and rigidity. However, to assure sufficient strength and rigidity while reducing the weight and the thickness of the transport container 14, a component of the container 14, which does not interfere with other members such as the supporting jig 15 combined with the container 14 when used, can be formed into a shape enabling increase of the section modulus of the portion. An appropriate portion, whose section modulus should be increased, is the connecting wall 19. Concave groove portions or ribs extending in an up-down direction at a plurality of places on the outer surface of the connecting wall 19. Alternatively, a concave step portion extending over the entire width of the transport container 14 is formed on an outer half portion of the top surface of the connecting wall 19. Thus, the section modulus of the connecting wall 19 is increased. Consequently, the weight of the container can be lightened. Also, the strength and the rigidity thereof can be assured.

In a case where the units 7, 7 are transported from the manufacturing factory to the assembly factory using the above transport container 14, and where the units 7, 7 are then set in a components supply portion of an assembly robot placed at the assembly factory, first, the units 7, 7 are accommodated in the accommodating spaces of the transport container 14. At that time, the units 7, 7 are accommodated therein so that the units 7, 7 are arranged in series in the longitudinal direction of each of the accommodating spaces 20, 20, and have the same posture, and so that the units 7, 7 can move in the longitudinal direction of each of the accommodating spaces 20, 20. More specifically, the units 7, 7 are accommodated therein in a state in which the direction of the central axis of each of the units 7, 7 is aligned with the width direction of the transport container 14, and in which the outer circumferential surfaces of the units 7, 7 adjoining with each other in the longitudinal direction of each of the accommodating spaces 20, 20 are made to be close to each other or made to abut against each other. The opening portion of each of the accommodating spaces 20, 20 is closed by the shutter member 22. Thus, the units 7, 7 do not come out from the opening portion. Also, as described above, the units 7, 7 are pushed into each of the accommodating spaces 20, 20 by elastically deforming the side wall portions of both the end walls 17, 17 and the intermediate walls 18, 18. Thus, upon completion of pushing the units 7, 7 thereinto, the units 7, 7 do not shake in each of the accommodating spaces 20, 20. Incidentally, even in a case where the width of each of the accommodating spaces 20, 20 is set to be slightly wider than that of each of the units 7, 7, so as to facilitate the taking of the units 7, 7 therefrom, as above described, the units 7, 7 do not shake therein to a problematic extent.

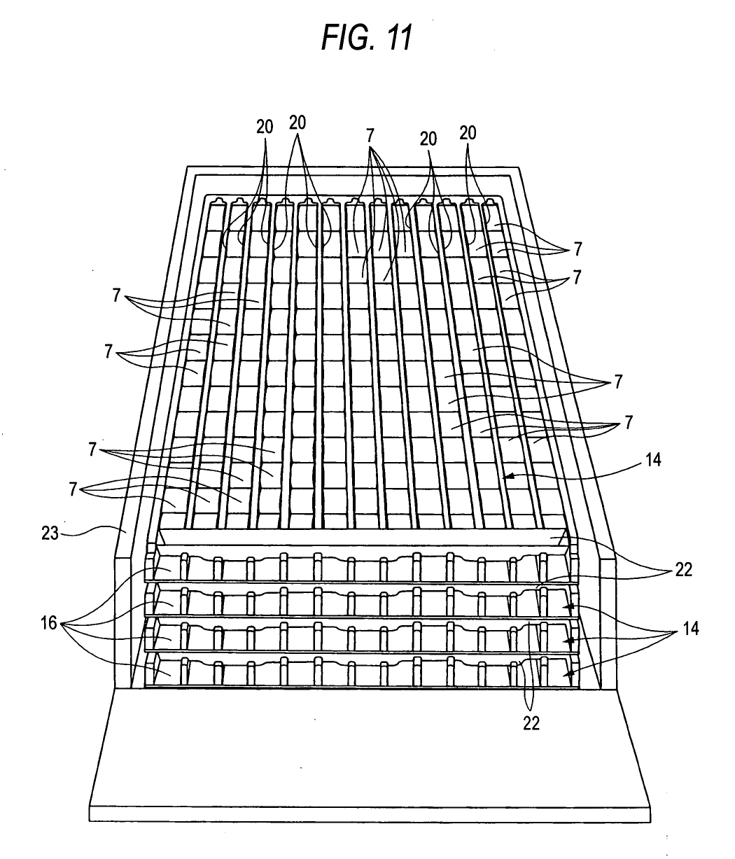

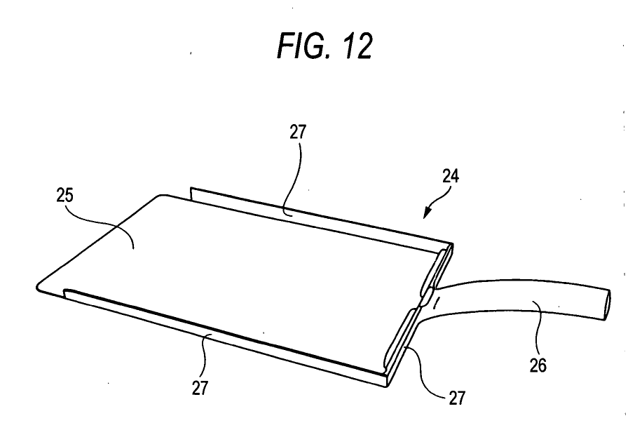

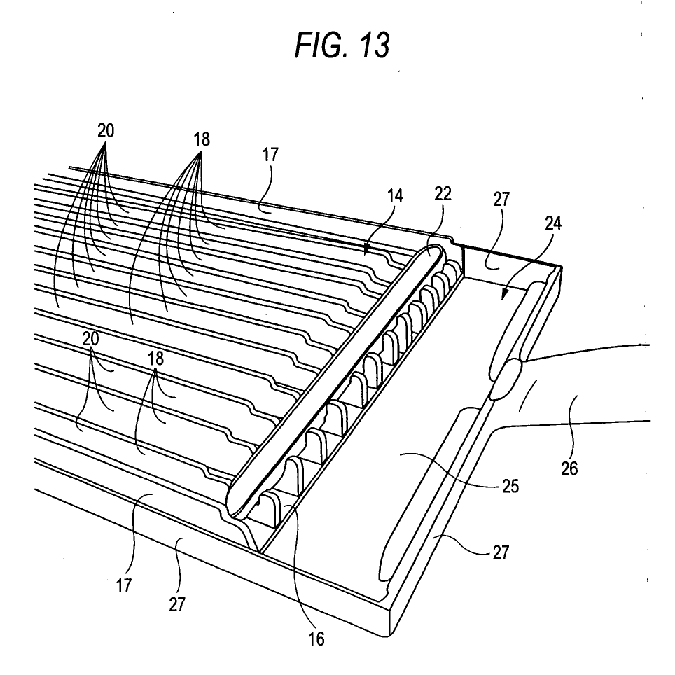

Thus, at the manufacturing factory, the units 7, 7 are accommodated in each of the accommodating spaces 20, 20 of the transport container 14. Then, a plurality of the containers 14, each of which accommodates a plurality of the units 7, 7, are stacked as a plurality of layers in an up-down direction, as shown in FIG. 11. At this time, a support plate 25 of a transferring jig 24 as shown in FIG. 12 is abut to a bottom surface of the component transport container 24 accommodating the plural unit 7 as shown in FIG. 13., and the bottom surface of each of the units 7, 7 accommodated in the accommodating spaces 20, 20 of an upper one of two transport containers directly stacked one on top of the other abuts against the top surface a corresponding one of the units 7, 7 accommodated in the accommodating spaces 20, 20 of the lower one of the two transport container 14. An operation of stacking a plurality of the transport containers 14, 14 each of which accommodates a plurality of the units 7, 7 is performed by simultaneously accommodating the plurality of the transport containers 14, 14 in a packaging 23, such as a cardboard box. As described above, by using the transferring jig 24, rigidity of the component transport container at the time of stacking is improved, and the breakage or deformation of the component transport container can be reduced.

Incidentally, a packaging of the side open type shown in FIG. 11 is used with a view to enabling an operation of taking the container 14, which accommodates the units 7, 7, using a transferring jig 24. As described above, the plurality of the transport containers 14, 14 stacked in an up-down direction, each of which accommodates the plurality of the units 7, 7, are put into a state, in which the plurality of the containers 14, 14 are accommodated in the packaging, and are transported to the assembly factory.

Note that although the transferring jig 24 shown in FIG.12 has a grip 26, the present invention is not limited to the configuration having the grip 26. For example, when the longitudinal length of the support plate 25 is longer than the longitudinal length of the component transport container 14, the component transport container can be handled by grabbing the longer component of the support plate 25 which is extended from the component transport container 14. Further, when transferring the component transport container by forklift or other industrial robot, the grip 26 can be suitably modified or omitted in accordance with the handling method.

Then, at the assembly factory, the packaging 23 is opened sideways, as shown in FIG. 11. The plurality of the transport containers 14, 14 stacked in an up-down direction, each of which accommodates the plurality of the units 7, 7, are taken out from the top layer, using the transferring jig as described above. The taken transport containers 14, 14 are transferred to the top surface of the supporting jig 15.

The transferring jig 24 is provided in the manufacturing factory and the assembly factory, and has a flat-plate-like support plate 25 and a gripper 26. Preferably, as long as the necessary strength and the necessary rigidity can be assured, the support plate 25 is as thin as possible so that the support plate 25 can be inserted into between the two transport containers 14, 14 stacked one on top of the other among the plurality of the transport containers 14, 14 each of which accommodates the plurality of units 7, 7. That is, the support plate 25 can be inserted under a lower surface of the stacked transport container 14. Thus, in an example illustrated in the figures, projection walls 27, 27 are fixedly provided along both the left and right edges and the base edge to support the support plate 25.

The projection wall 27 also functions as protecting the end wall 17 of the component transport container which is easy to be broken or deformed.

Additionally, as schematically shown in FIG. 1, the supporting jig 15 is configured by forming a plurality of supporting walls 29, 29, each of which has sufficient rigidity and strength, on the top surface of a base plate 28 that is formed of a steel plate or an aluminum plate and that has sufficient rigidity and strength. A pitch, at which the supporting walls 29, 29 are formed, is equal to that at which both the end walls 17, 17 and the intermediate walls 18, 18 are formed in the width direction of the transport container 14. The width (or thickness), the length, and the height of each of the supporting walls 29, 29 are set so that the supporting walls 29, 29 can be inserted into the walls 17 and 18.

At the assembly factory, an operation of transferring the plurality of the transport containers 14, 14, each of which accommodates the plurality of the units 7, 7, onto the top surface of the supporting jig 15 is performed as follows. First, as illustrated in FIG. 11, the packaging 23 is opened sideways in one end portion in the longitudinal direction of each of the transport containers 14, 14. Subsequently, the support plate 25 of the transferring jig 24 is inserted under the transport container 14 of the top layer. As shown in FIG. 13, this transport container 14 is taken out of the packaging 23, together with the units 7, 7 (FIG. 13 shows a state of the container 14 by omitting the units 7, 7). Thereafter, this transport container 14 is transferred from the top surface of the support plate 25 to the top surface of the supporting jig 15. This transferring operation is performed as follows. That is, in a state in which the support plate 25 is placed above the substrate 28 of the supporting jig 15, the transport container 14 is slid with respect to the support plate 25. Then, the transport container 14 is moved onto the base plate 28 while the supporting walls 29, 29 are caused to go into both the end walls 17, 17 and the intermediate walls 18, 18, respectively. Until the transferring operation, the shutter member 22 is maintained in a state in which the shutter member 22 is mounted on the transport container 14.

In a state in which the transport container 14 accommodating the units 7, 7 is transferred onto the top surface of the supporting jig 15, the bottom plate portion 16 and the walls 17 and 18 are not deformed into an inappropriate shape. Thus, the transport container 14 is set at the components supply portion of the assembly robot while the transport container 14 is placed on the top surface of the supporting jig 15. Also, the shutter member 22 is removed from the transport container 14. In this state, the units 7, 7 accommodated in the accommodating spaces 20, 20 are pushed out one by one and are taken out from the opening at the end portion of each of the accommodating spaces 20, 20. At that time, a leading end portion of a push-out arm provided on the assembly robot is inserted into each of insertion concave portions 30, 30 provided in an inner end portion of each of the accommodating spaces 20, 20. Subsequently, the push-out arm is moved toward the opening portion of each of the accommodating spaces 20, 20 pitch by pitch. Then, the units 7, 7 are taken out one by one through the openings portion. When all the units 7, 7 accommodated in one of the accommodating spaces 20, 20 are taken out therefrom, the transport container 14 is moved in the width direction thereof by one pitch at which the accommodating spaces 20, 20 are arranged. Then, a similar operation is repeated.

Incidentally, after the transferring operation, the shutter member 22 can manually be replaced with a shutter that is made of a metal such as an aluminum alloy, that has a higher strength and a higher rigidity and that is adapted to be used in the assembly factory. A reason for replacing the shutter member 22 with such a shutter for use in the assembly factory is that because the shutter member 22 originally provided in the transport container 14 is too light and is low in strength and rigidity, it may be difficult to surely remove the shutter member 22 even when set in the components supply portion of the assembly robot. Additionally, the thin-walled shutter member 22 made of the synthetic resin may be undetected when the shutter member 22 is dropped by the arm of the assembly robot and enters some portion of the assembly robot. In contrast, in the case where the shutter member 22 is replaced with the shutter for use in the assembly factory, the latter shutter can surely be removed by the assembly robot. Also, even when this shutter is dropped and enters some portion of the assembly robot, this shutter can surely be detected by a metal detector. Thus, this shutter can be removed.

In accordance with the component transport method, the component transport container 14, and the combination of the component transport container 14 and the supporting jig 15 according to the present embodiment, the distribution cost of components is reduced. Thus, the cost of the units 7, 7 can be reduced. Reasons therefor are described below.

First, the material cost and the manufacturing cost of the component transport container 14 are suppressed to low values, because the component transport container 14 is thin-walled and is made of the high polymer material, such as PP. This fact results in elimination of the necessity for sending back the component transport container 14 after the units 7, 7 are taken out of the accommodating spaces of the component transport container 14 at the assembly factory. The high polymer material, such as PP, can be reutilized by performing the separate collection thereof. The reuse of the material can be performed by transferring the material to collection traders from the assembly factory. Accordingly, the transportation cost of sending back the empty component transport container 14 to the manufacturing factory is eliminated. Consequently, the cost of the components can be reduced.

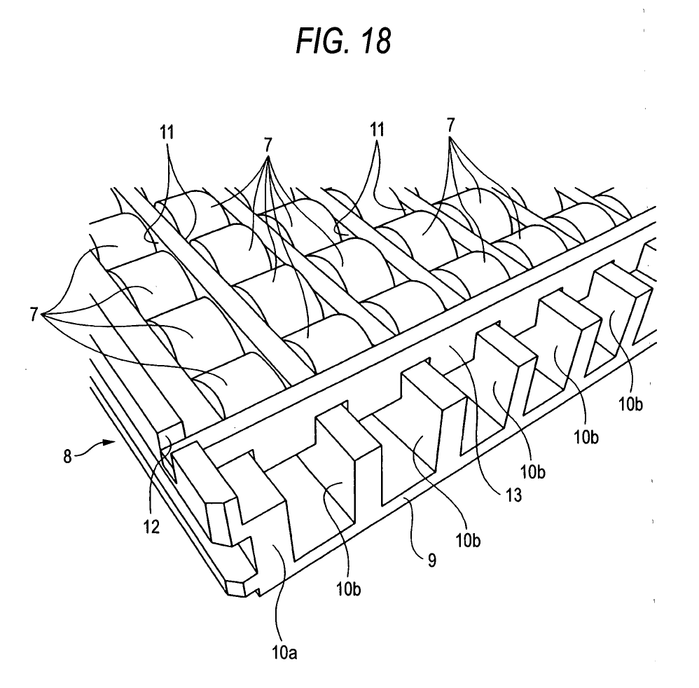

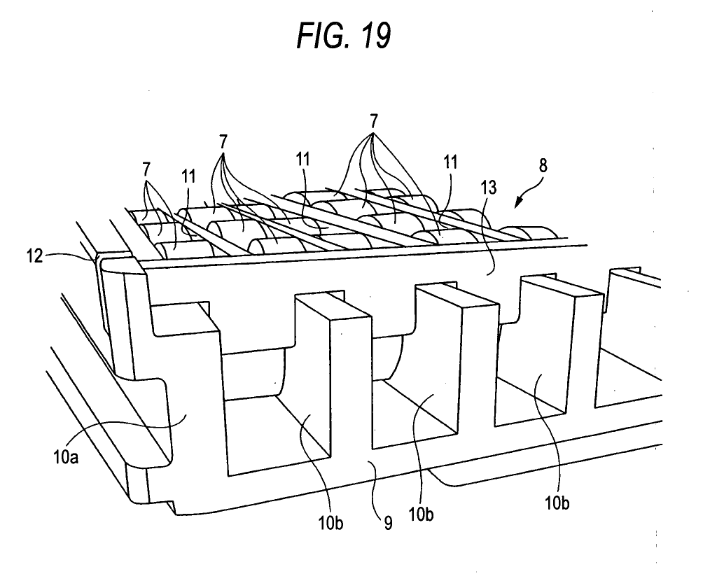

Also, because the component transport container 14 is made of resin, the weight of the component transport container 14 can be suppressed to small values. Thus, the number of the component transport containers 14 accommodated in unit capacity can be increased (that is, accommodating efficiency can be increased). Also, the transportation cost per unit 7 can be suppressed to a low value by reducing the weight of portions (needed for packing) other than the units 7, 7. For example, in the case of using the aforementioned aluminum-alloy component transport container 8 shown in FIGS. 17 to 19, a value obtained by dividing the weight of the transport container 8 by the number of the units 7, 7, which can be accommodated in the container 8, is 7.9 g. In contrast, in the case of using the component transport container 14 according to the present embodiment of the invention, such a value is suppressed to 0.25 g. Thus, the weight of the entire article to be transported from the manufacturing factory to the assembly factory can considerably be reduced. Consequently, the transportation cost and the transport price of the units 7, 7 transported to the assembly factory can be reduced.

However, because the component transport container 14 is made of a high polymer material, the rigidity of the component transport container 14 is reduced. This may result in that the positioning of each of the components accommodated in the component transport container is unstable, and at the time of stacking the component transport container 14 or taking out one component transport container 14 from the stacked component transport containers 14, the component transport container 14 can be broken or deformed. When the component transport container 14 is broken or deformed, the component transport container 14 cannot be set in the assembly robot in predetermined positional relationship at the assembly factory.

In contrast, according to the invention, at the time of stacking, stacking the component transport container 14 is performed after combining the component transport container 14 with the transferring jig 24. Thus, the rigidity of the whole of the stacked component transport container 14 is compensated. Further, at the time of taking out one component transport container 14 from the stacked component transport containers 14, by employing the transferring jig 24, the rigidity of the component transport container 14 is compensated.

In addition, according to the invention, before the components are taken out of the component transport container at the assembly factory, the component transport container is placed on the supporting jig. Then, the supporting walls are inserted into both the end walls and the intermediate walls. In this state, both the end walls and the intermediate walls, which are made of a thin synthetic resin material and are hollow, are supported by the supporting walls. Thus, the shapes of both the end walls and the intermediate walls are stabilized. Therefore, the components can stably be taken out in the same posture by taking out the components through the opening portion formed between the same side end portions in the longitudinal direction of the adjacent two of both the end walls and the intermediate walls.

The aforementioned description has been given of a case where the invention is utilized for transporting the unit 7 in which the plurality of needle rollers 4, 4 are stuck onto the inner circumferential surface of the roller 3. However, the invention can be utilized for transporting not only such units 7 but various small components to be conveyed from a component factory to an assembly factory without changing the posture of each of the components.

What is claimed is:

1. A component transport method using a component transport container and a transferring jig,
the component transport container that accommodates plural components along with a longitudinal direction and is made of high polymer material, the component transport container comprising:
a bottom plate;
a pair of end walls provided on width direction both ends thereof;
plurality of intermediate walls provided between the end walls;
a connecting wall that is provided on one end and connects one end of the end wall to one end of the intermediate wall;
a component accommodating space surrounded by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side,
the transport method comprising:
accommodating the plurality of components into the component accommodating space along with the longitudinal direction;
inserting a support plate of the transferring jig under a lower surface of the component transport container and stacking the component transport containers; and
transporting the component transport containers while the component transport containers are stacked state.

2. A component transport method using a component transport container and a supporting jig,
the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounded by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side,
the supporting jig supporting the component transport container from lower side and comprising:
a base plate supporting the bottom plate of the component transport container; and
a supporting wall inserted into the hollow structure,
wherein the supporting jig has rigidity higher than that of the component transport container,
the transport method comprising:
inserting the supporting wall of the supporting jig into the hollow structure of the component transport container; and
taking out the component from the taking out opening.

3. The component transport method according to claim 2, wherein
from a state of closing the taking out opening which is closed by engaging respective cutout portions provided on the other end of the respective intermediate walls of the component transport container with a shutter member extending in the width direction, the shutter member is removed from the taking out opening, and
the component is taken out from the taking out opening.

4. The component transport method according to claim 2, wherein
from a state of stacking the plural component transport container, a transferring jig provided with a support plate is inserted under a lower surface of an upper most component transport container and the upper most component transport container is removed, and
the removed upper most component transport container is transferred to an upper surface of the supporting jig from the support plate of the transferring jig and the supporting wall of the supporting jig is inserted into the hollow structure of the component transport container.

5. The component transport method according to claim 3, wherein
from a state of stacking the plural component transport container, a transferring jig provided with a support plate is inserted under a lower surface of an upper most component transport container and the upper most component transport container is removed, and
the removed upper most component transport container is transferred to an upper surface of the supporting jig from the support plate of the transferring jig and the supporting wall of the supporting jig is inserted into the hollow structure of the component transport container.

6. A combination structure of a component transport container and a supporting jig, the combination structure comprising:
the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounding by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side; and
the supporting jig supporting the component transport container from lower side and comprising:
a base plate supporting the bottom plate of the component transport container; and
a supporting wall inserted into the hollow structure,
wherein the supporting jig has rigidity higher than that of the component transport container,
wherein supporting wall of the supporting jig is inserted into the hollow structure of the component transport container.

7. A combination structure of a component transport container and a transferring jig, the structure comprising:
the component transport container that accommodates plural components along with a longitudinal direction and is made of high polymer material, the component transport container comprising:
a bottom plate;
a pair of end walls provided on width direction both end thereof;
plurality of intermediate walls provided between the end walls;
a connecting wall that is provided on one end and connects one end of the end wall to one end of the intermediate wall;
a component accommodating space surrounding by the bottom plate, the end wall, the intermediate wall and the connecting wall, and/or the bottom plate, the plural intermediate walls and the connecting wall; and
a taking out opening provided on other end of the component accommodating space,
wherein at least the pair of the end wall and the at least one of the intermediate walls have hollow structure which opens to the bottom plate side; and
the transferring jig comprising a support plate,
wherein the support plate of the transferring jig supports the component transport container from lower side.
